(19) United States
(12) Patent Application Publication
(10) Pub. No.: US 2010/0220239 A1
(43) Pub. Date: Sep. 2, 2010

(54) INTERPOLATION FRAME GENERATION APPARATUS, INTERPOLATION FRAME GENERATION METHOD, AND BROADCAST RECEIVING APPARATUS

(76) Inventors: Yohei Hamakawa, Fussa-shi (JP); Masaya Yamasaki, Ome-shi (JP); Ko Sato, Akishima-shi (JP); Keiko Hirayama, Tokyo (JP); Himio Yamauchi, Yokohama-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/782,609

(22) Filed: May 18, 2010

Related U.S. Application Data
(63) Continuation of application No. PCT/JP2008/071172, filed on Nov. 14, 2008.

(30) Foreign Application Priority Data
Dec. 26, 2007 (JP) 2007-335349

(51) Int. Cl. H04N 5/14

(52) U.S. Cl. 348/699; 348/E05.062

(57) ABSTRACT

According to one embodiment, an interpolation frame generation apparatus according to one embodiment, which generates an interpolation frame image to be inserted between continuous frame images, includes a block specific detector configured to execute block matching processing in one of blocks included in the continuous frame images and determine a block specific motion vector, a pixel specific detector configured to, for each pixel of a block of interest of the blocks, define, as a candidate vector, a motion vector most frequently applied among pixel specific motion vectors already determined in a block adjacent to the block of interest and execute matching processing between the candidate vector and each pixel of the block of interest, thereby detecting a pixel specific motion vector, and a generator configured to generate an interpolation frame image based on the block specific motion vector and the pixel specific motion vector.

### CROSS-REFERENCE TO RELATED APPLICATIONS

This is a Continuation Application of PCT Application No. PCT/JP2008/071172, filed Nov. 14, 2008, which was published under PCT Article 21(2) in English.

This application is based upon and claims the benefit of priority from Japanese Patent Application No. 2007-335349, filed Dec. 26, 2007, the entire contents of which are incorporated herein by reference.

### BACKGROUND

1. Field

One embodiment of the invention relates to an interpolation frame generation apparatus, interpolation frame generation method, and broadcast receiving apparatus, which detect a motion vector of each block and that of each pixel of frame images and perform interpolation processing based on the motion vectors.

2. Description of the Related Art

As is known, digital television apparatuses with flat display panels are recently becoming popular. Such a digital television apparatus incorporates an interpolation processing apparatus which executes interpolation image processing for a video signal to obtain smooth image display. The interpolation processing apparatus detects a motion vector of each block and that of each pixel and performs interpolation processing based on it.

Jpn. Pat. Appln. KOKAI Publication No. 2005-284486 discloses a technique of selecting, as the motion vector candidates of a pixel of interest, the motion vectors of four blocks on the upper, lower, left, and right sides of a block of interest including the pixel of interest. A motion vector which minimizes the pixel value difference between the first field and the second field is determined as the motion vector of the pixel of interest.

In the technique disclosed in Jpn. Pat. Appln. KOKAI Publication No. 2005-284486, interpolation processing is performed by referring to the motion vectors of the blocks around the block of interest. However, the temporal continuity of the motion vectors is not sufficiently used for motion vector detection.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the arrangement of an interpolation frame generation apparatus according to an embodiment of the invention;

FIG. 2 is an explanatory view showing an example of block matching processing of the interpolation frame generation apparatus according to the embodiment;

FIG. 3 is an exemplary flowchart illustrating overall interpolation image generation processing in the interpolation frame generation apparatus according to the embodiment;

FIG. 4 is an exemplary view for explaining processing of determining each pixel specific motion vector of a block of interest on the basis of the motion vectors of neighboring blocks in the interpolation frame generation apparatus according to the embodiment;

FIG. 5 is an exemplary view for explaining processing of determining each pixel specific motion vector of a block of interest on the basis of the most frequently applied vectors of neighboring blocks in the interpolation frame generation apparatus according to the embodiment;

FIG. 6 is an exemplary view for explaining processing of determining each pixel specific motion vector of a block of interest on the basis of the most frequently applied vectors of neighboring blocks in the interpolation frame generation apparatus according to the embodiment;

FIG. 7 is an exemplary flowchart illustrating processing of determining each pixel specific motion vector of a block of interest on the basis of the most frequently applied vectors of neighboring blocks in the interpolation frame generation apparatus according to the embodiment;

FIG. 8 is an exemplary flowchart illustrating processing of determining each pixel specific motion vector of a block of interest on the basis of the most frequently applied vectors of neighboring blocks in the interpolation frame generation apparatus according to the embodiment; and

FIG. 9 is an exemplary block diagram showing a broadcast receiving apparatus using the interpolation frame generation apparatus according to the embodiment.

### DETAILED DESCRIPTION

Various embodiments according to the invention will be described hereinafter with reference to the accompanying drawings. In general, an interpolation frame generation apparatus according to one embodiment of the invention generates an interpolation frame image to be inserted between continuous frame images, the interpolation frame generation apparatus comprises a block specific detector configured to execute block matching processing in one of blocks included in the continuous frame images and determine a block specific motion vector, a pixel specific detector configured to, for each pixel of a block of interest of the blocks, define, as a candidate vector, a motion vector most frequently applied among pixel specific motion vectors already determined in a block adjacent to the block of interest and execute matching processing between the candidate vector and each pixel of the block of interest, thereby detecting a pixel specific motion vector, and a generation module configured to generate an interpolation frame image based on the block specific motion vector and the pixel specific motion vector.

An embodiment of the invention will now be described with reference to the accompanying drawing.

<Example of Arrangement of Interpolation Frame Generation Apparatus According to Embodiment of Invention>

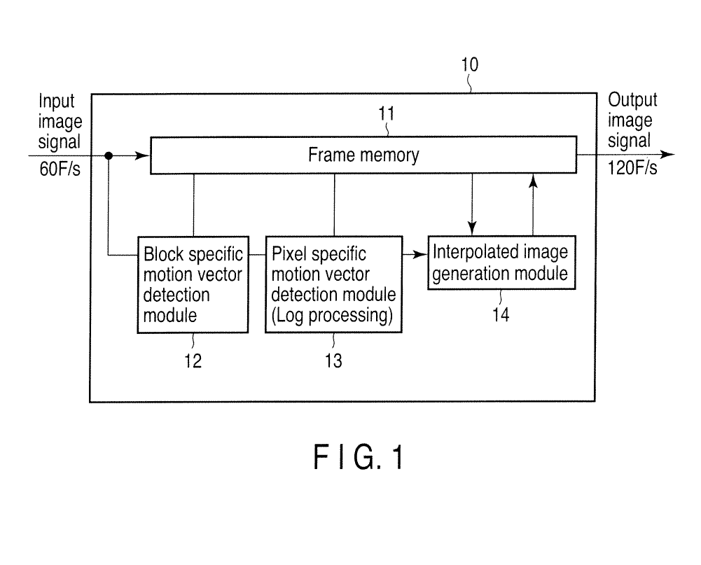

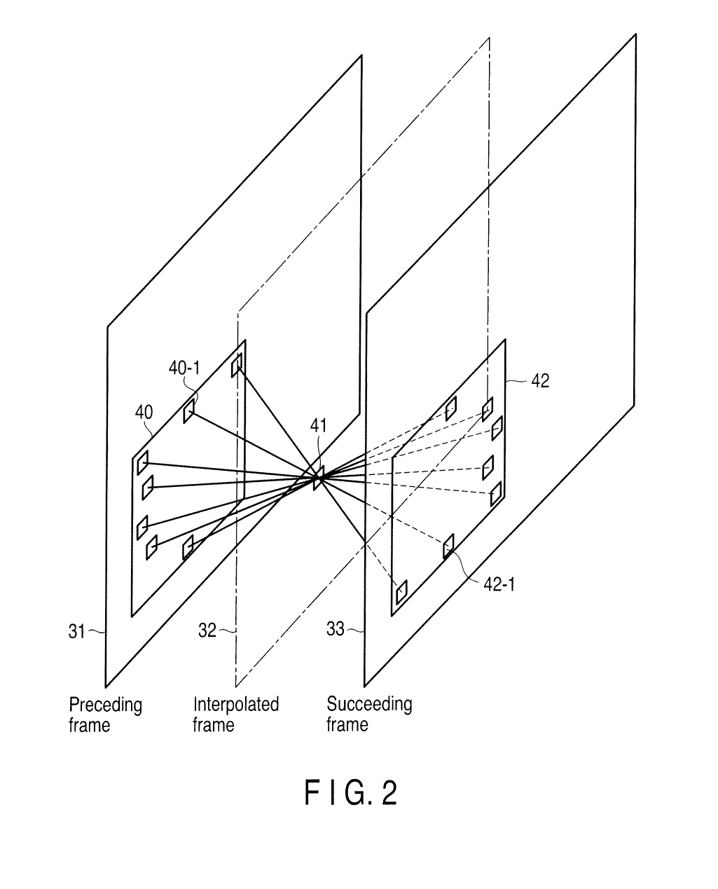

An example of the arrangement of an interpolation frame generation apparatus according to an embodiment of the invention will be described first in detail with reference to the accompanying drawing. FIG. 1 is a block diagram showing an example of the arrangement of an interpolation frame generation apparatus according to an embodiment of the invention. FIG. 2 is an explanatory view showing an example of block matching processing of the interpolation frame generation apparatus.

As shown in FIG. 1, an interpolation frame generation apparatus 10 according to an embodiment of the invention has a frame memory 11 which receives an input image signal, a block specific motion vector detection module 12 which receives the input image signal from the input terminal and the frame memory 11, a pixel specific motion vector detection module 13 which receives block specific motion vector information from the block specific motion vector detection module 12 and performs log processing to be described later, and an interpolated image generation module 14 which receives the input image signal from the frame memory 11 and generates an interpolation image.

With this arrangement, the interpolation frame generation module 10 according to the embodiment of the invention generates an interpolation frame 32 and inserts it between a preceding frame 31 and a succeeding frame 33 to change an input signal of 60 f/s to an input signal of 120 f/s, as shown in FIG. 2. At this time, the interpolated image generation module 14 generates the interpolation frame 32 based on a motion vector detected by the block specific motion vector detection module 12.

More specifically, the block specific motion vector detection module 12 performs block matching processing between the preceding frame 31 and the succeeding frame 33 based on a fixed-length block shown in FIG. 2, thereby detecting a motion vector. This will be described below in detail with reference to the accompanying drawing.

<Example of Interpolation Frame Generation Processing of Interpolation Frame Generation Apparatus According to Embodiment of Invention>

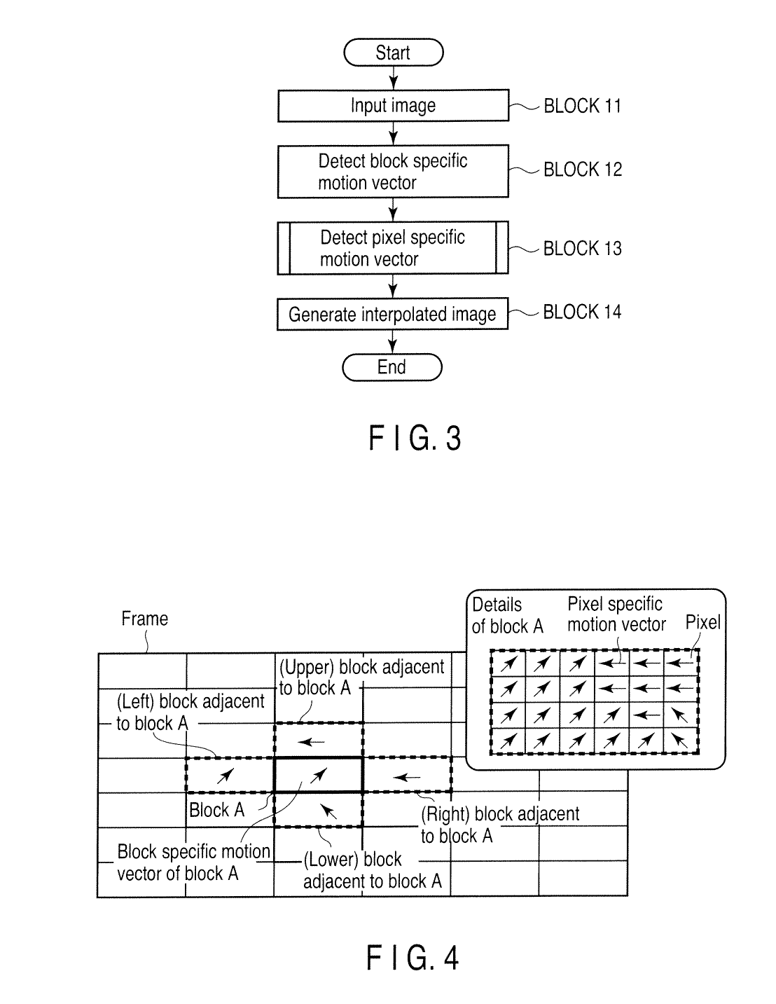

The outline of the operation of interpolation frame generation processing in the interpolation frame generation apparatus having the above-described arrangement will be described in detail with reference to FIG. 3. FIG. 3 is a flowchart illustrating an example of overall interpolation image generation processing in the interpolation frame generation apparatus according to the embodiment of the invention. FIG. 4 is a view for explaining processing of determining each pixel specific motion vector of a block of interest on the basis of the motion vectors of neighboring blocks in the interpolation frame generation apparatus.

The blocks of the flowcharts in FIGS. 3, 7, and 8 to be described below can be replaced with circuit blocks. Hence, all the blocks of the flowcharts can be redefined as blocks.

(Outline of Interpolation Frame Generation Processing)

In the interpolation frame generation module 10 according to the embodiment of the invention, first, a video signal of 60 F/s is supplied to the frame memory 11 and the block specific motion vector detection module 12, as shown in the flowchart of FIG. 3 (block 11).

The frame memory 11 and the block specific motion vector detection module 12 detect each block specific motion vector (block 12). In this processing, one frame is divided into blocks, and a motion vector is detected in each block, as shown in FIG. 4.

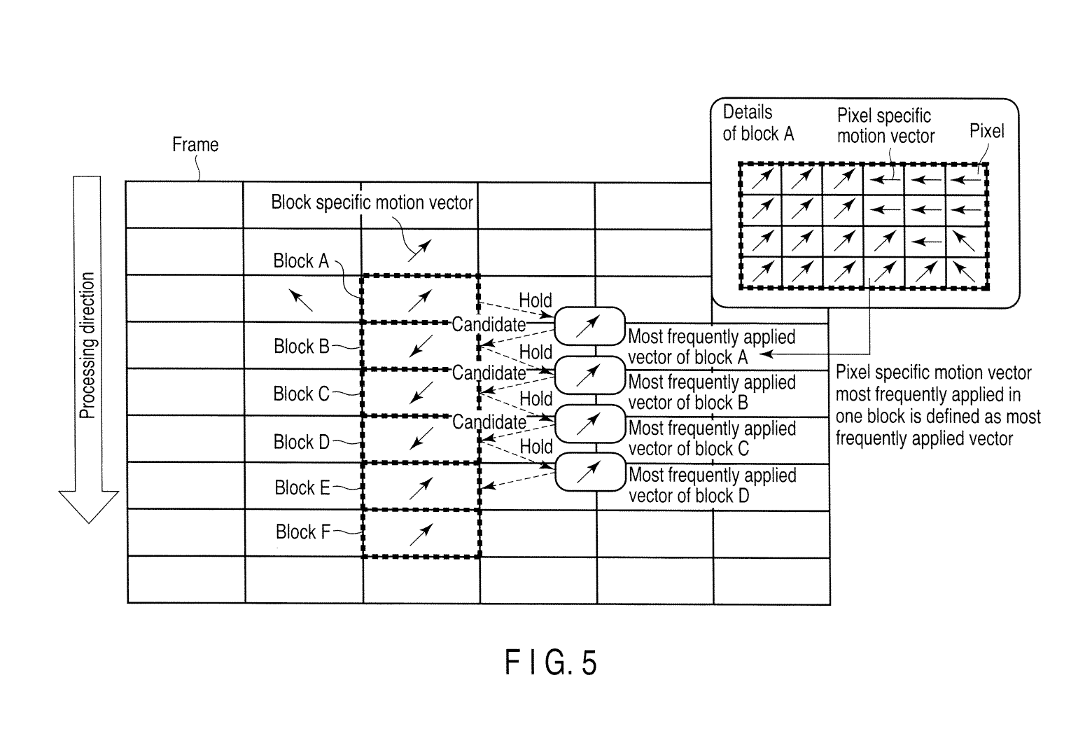

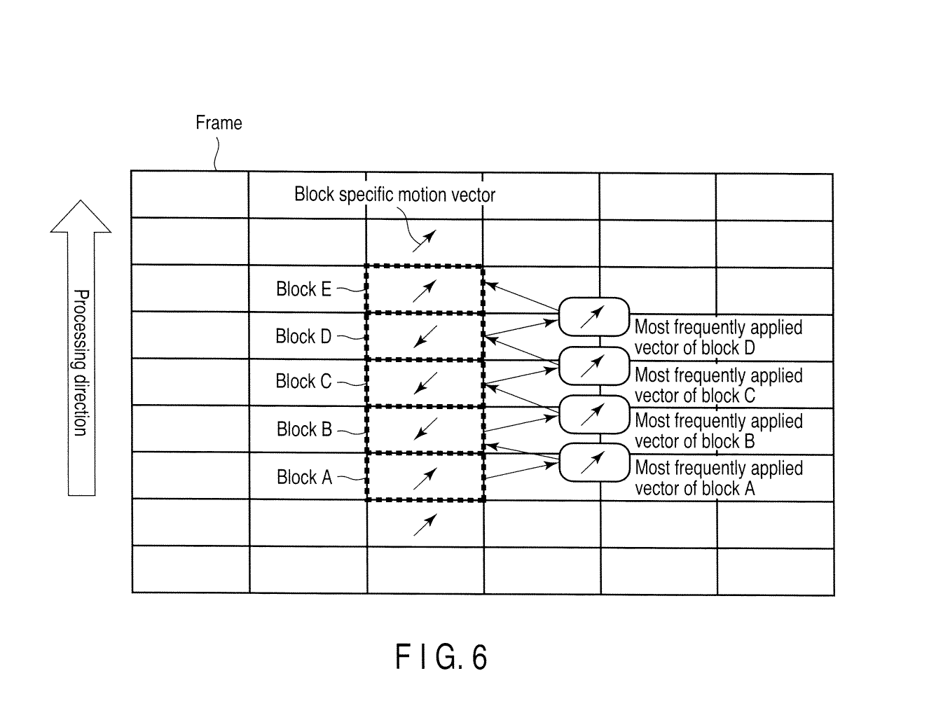

The frame memory 11 and the pixel specific motion vector detection module 13 detect pixel specific motion vectors in one block of interest, as indicated by details of a block A in FIG. 4 and shown in the explanatory views of FIGS. 5 and 6 (block 13). The method of detecting the pixel specific motion vectors is the feature of the embodiment of the invention and will be described later in detail with reference to the accompanying drawing.

After that, the interpolated image generation module 14 generates an interpolation image based on the detected block specific motion vectors and pixel specific motion vectors and inserts it in the video signal of 60 f/s, as needed, in cooperation with the frame memory 11 so that a video signal of 120 f/s is output. If a video signal of 50 f/s is input, a video signal of 100 f/s is output.

(Details of Pixel Specific Motion Vector Detection Processing)

Purport

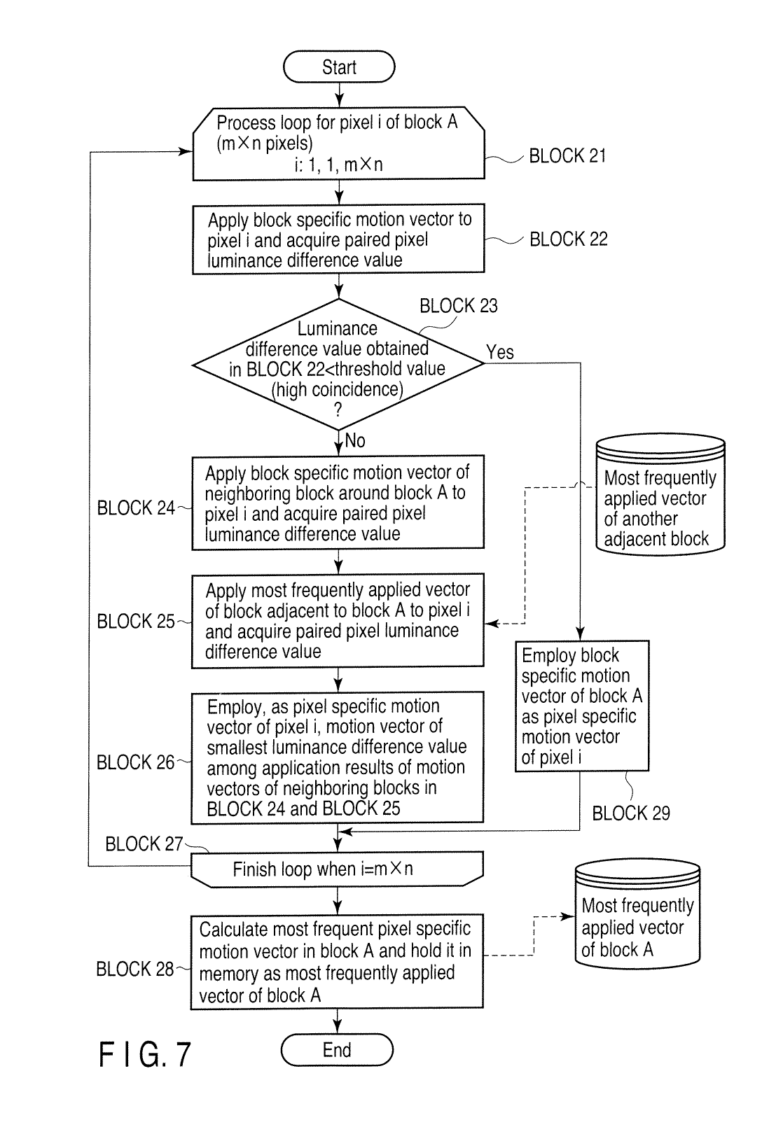

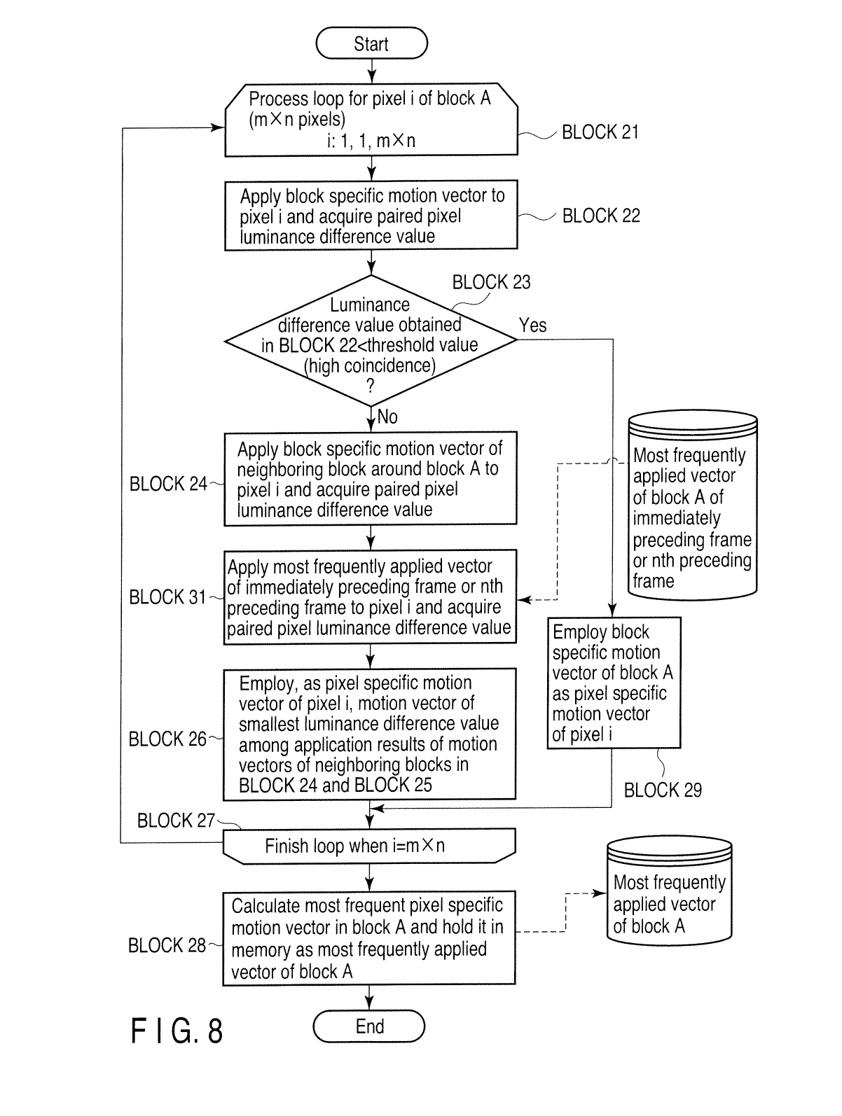

The operation of pixel specific motion vector detection processing in block 13 of the flowchart in FIG. 3 will be described next in detail with reference to the flowcharts in FIGS. 7 and 8.

Pixel specific motion vector detection processing of the pixel specific motion vector detection module 13 is executed for one block A of interest. The paired pixel luminance difference value between each pixel of the preceding frame and a corresponding pixel of the succeeding frame is obtained, which is designated when applying “motion vector candidates” to each pixel in the block A of interest. A motion vector that gives a minimum paired pixel luminance difference value is adopted as a pixel specific motion vector.

In this embodiment, “motion vector candidates” to be described below are prepared.

1) The block specific motion vectors obtained in block 12 for the block A of interest

2) The block specific motion vectors of neighboring blocks (four blocks on the upper, lower, left, and right sides) adjacent to the block A of interest

3) Pixel specific motion vectors which are most frequently applied in determining pixel specific motion vectors in the blocks adjacent to the block A of interest (log information)

The pixel specific motion vector detection module 13 obtains paired pixel luminance difference values by applying three kinds of “motion vector candidates” to each pixel of the block A of interest and adopts a motion vector that gives a minimum paired pixel luminance difference value as a pixel specific motion vector.

The reason why the “most frequently applied vectors” of log information 3) are processed as the “motion vector candidates” will be described below.

In the method of using the block specific motion vector of each adjacent block as a pixel specific vector candidate in the block A of interest, a normal operation can be expected assuming that one of the adjacent blocks holds a correct motion vector.

In block specific motion vector detection processing using block matching, however, detection errors normally occur (incorrect vectors are obtained) due to various factors. If detection errors have occurred in a few blocks around the block of interest, a correct motion vector can be obtained from another adjacent block without detection errors.

However, if blocks with detection errors continuously exist around the block of interest, it is impossible to estimate a correct pixel specific motion vector candidate. Consequently, an erroneous motion vector may be applied, adversely affecting the quality of the interpolation frame.

To raise the detection accuracy, the “most frequently applied vectors” of log information are also used as the pixel specific motion vector candidates in addition to the block specific motion vectors of the neighboring blocks.

The characteristic features of the “most frequently applied vector” will be described below on the basis of the example shown in FIG. 5.

1. All pixel specific motion vectors in a block A (n×m pixels) are determined. Of the pixel specific motion vectors employed in the block A, motion vectors in the largest number (of high frequency) are held in the memory and defined as the “most frequently applied vector” of the block A.

2. Blocks B to F, which are different from the block A, are assumed to have a continuous positional relationship.

3. When detecting the pixel specific motion vector of each pixel in the block B, the “most frequently applied vector” obtained in the block A is used as a pixel specific motion vector candidate together with the motion vectors of the neighboring blocks around the block B.

4. Assume that the neighboring blocks around the block B include only motion vectors having low coincidences (estimated to be incorrect). In this case, the most frequently applied vector” of the block A is used. That is, a likely motion vector that has most frequently won in at least the adjacent (highly correlative) block A (the “most frequently applied vector” of the block A) is used. This increases the possibility of applying a likely motion vector even for a specific pixel in the block B.

5. The “most frequently applied vector” is calculated in the block B as well. Another block C adjacent to the block B can use the “most frequently applied vector” of the block B as a candidate.

6. If the “most frequently applied vector” of the block B is the same as that of the block A, the “most frequently applied vector” of the block A propagates to the block C as a pixel specific motion vector candidate. The “most frequently applied vector” may also propagate to other continuous blocks such as the block D, . . . .

FIG. 5 assumes blocks which continue in the vertical direction. This is because normal image processing progresses from the upper side to the lower side of the screen. That is, the pixel specific motion vectors in an upper block are determined prior to those in a lower block on the screen. When the “most frequently applied vector” propagates, as in this embodiment, the propagation is generally assumed to occur from the upper side to the lower side.

However, the “most frequently applied vector” of this embodiment can propagate in any direction other than that described above. Processing may sequentially be done in, e.g., the horizontal direction, i.e., from the left side to the right side of the screen or from the right side to the left side of the screen. Processing may sequentially be performed from the lower side to the upper side of the screen, as shown in FIG. 6.

Deserving special note is the feature 6. The blocks A and D appear to have a low spatial correlation, and using the “most frequently applied vector” obtained in the block A as a candidate in the block D may be perceived as a problem. However, it is not necessarily so.

Assume that the blocks A and D actually have no correlation. When the “most frequently applied vector” of the block A is used in the block D, the coincidence is low. Instead, a correct motion vector can be obtained by referring to the motion vectors of the neighboring blocks around the block D. Hence, normally, a problem rarely rises.

On the other hand, if the block specific motion vectors should continue from the block A to the block E, but incorrect block specific motion vectors are continuously obtained in the blocks B to D (when the blocks A to E should have identical correct motion vectors, but the blocks B, C, and D in the middle have incorrect motion vectors), it is possible to make the most of the feature 6.

At this time, the correct pixel specific motion vector of each pixel of the block B can be obtained using the “most frequently applied vector” of the block A (the “most frequently applied vector” of the block B is expected to be the motion vector that has most frequently won in the block A). Additionally, since the “most frequently applied vector” propagates to the blocks C and D, all the blocks B to D can obtain correct pixel specific motion vectors.

Explanation Using Flowcharts

Details of pixel specific motion vector detection processing will be described below with reference to the flowcharts in FIGS. 7 and 8.

The pixel specific motion vector detection module 13 starts the process loop of the block A (m×n pixels) in cooperation with the frame memory 11 (block 21). That is, the pixel specific motion vector detection module 13 repeatedly executes the processing in blocks 22 to 26 for all pixels of the block A (m×n pixels) from the start of the process loop in block 21 to the end of the process loop in block 27.

More specifically, the pixel specific motion vector detection module 13 applies a block specific motion vector to a pixel i in the block A and calculates the luminance difference value (paired pixel luminance difference value) between a pair of pixels (a pair of pixels on the preceding and succeeding frames designated by the vector) (block 22).

If the calculated paired pixel luminance difference value is smaller than a predetermined threshold value, the pixel specific motion vector detection module 13 determines that the vector is appropriate (block 23) and employs the motion vector as the pixel specific motion vector of the pixel i (block 29).

However, if the calculated paired pixel luminance difference value is equal to or larger than the predetermined threshold value, the pixel specific motion vector detection module 13 determines that the vector is incorrect (block 23) obtains a new paired pixel luminance difference value corresponding to each of candidates which are block specific motion vectors of neighboring blocks (normally four blocks on the upper, lower, left, and right sides) (block 24).

The pixel specific motion vector detection module 13 (log processing) applies a “most frequently applied vector” which is the log information of a block adjacent to the block A to the pixel i and acquires the paired pixel luminance difference value (block 25).

The pixel specific motion vector detection module 13 employs the smallest one of the paired pixel luminance difference values as the pixel specific motion vector of the pixel i (block 26).

This processing is repeatedly executed for all pixels in the block A (m×n pixels). After the pixel specific motion vectors of all pixels of the block A are obtained (block 27), the pixel specific motion vector detection module 13 calculates a most frequent motion vector as the “most frequently applied vector” of the block A. The “most frequently applied vector” is held in the memory (block 28).

In this embodiment, it is possible to propagate a pixel specific motion vector which most frequently coincides in a block to other adjacent blocks as the “most frequently applied vector”. Even when blocks continuously have incorrect motion vectors, a correct motion vector can be applied at a high possibility. It is consequently possible to increase the quality of the created interpolation frame.

As another embodiment, the “most frequently applied vector” acquisition target may be not a block adjacent to the block A but a block A of interest of an immediately preceding frame (or the nth preceding frame; n is an integer), as shown in FIG. 8.

As described above in detail, the interpolation frame generation apparatus according to the embodiment of the invention accurately detects a pixel specific motion vector using not only the motion vector of a block adjacent to a block of interest as a motion vector acquisition target but also the “most frequently applied vector” of each pixel, which is the log information of the adjacent block, and performs reliable interpolation processing based on the pixel specific motion vector.

<Example of Arrangement of Broadcast Receiving Apparatus Using Interpolation Frame Generation Module of Embodiment of Invention>

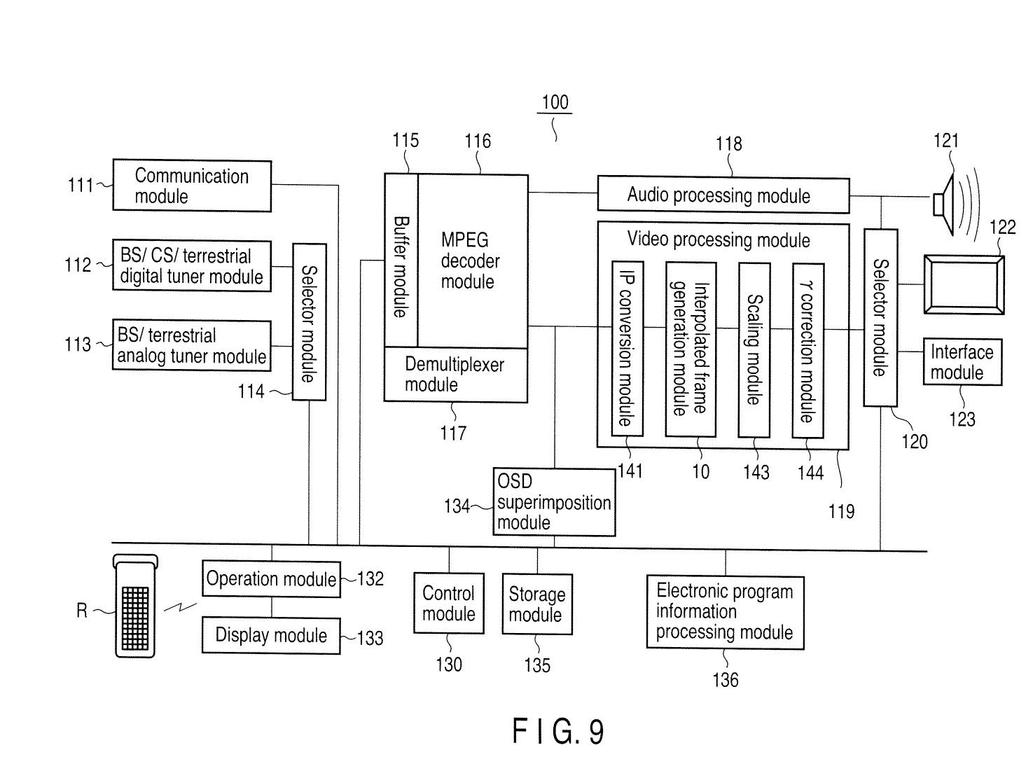

An example of a broadcast receiving apparatus using the interpolation frame generation module according to the embodiment of the invention will be described next with reference to the accompanying drawing. FIG. 9 is a block diagram showing an example of the arrangement of a broadcast receiving apparatus using the interpolation frame generation module according to the embodiment of the invention.

In a broadcast receiving apparatus 100, the above-described interpolation frame generation module is preferably used as an interpolation frame generation module 10 in a video processing module 119.

(Arrangement and Operation of Broadcast Receiving Apparatus)

An example of the arrangement of a broadcast receiving apparatus such as a digital television apparatus, which is an embodiment of the broadcast receiving apparatus using the interpolation frame generation module of the embodiment of the invention, will be described below in detail with reference to the accompanying drawing. FIG. 9 is a block diagram showing an example of the arrangement of a broadcast receiving apparatus such as a digital television apparatus, which is an embodiment of the broadcast receiving apparatus using the interpolation frame generation module.

As shown in FIG. 9, the broadcast receiving apparatus 100 is, e.g., a television apparatus. A control module 130 is connected to the modules via data bus to control the overall operation. The broadcast receiving apparatus 100 includes, as main constituent elements, an MPEG decoder module 116 which constitutes the playback side, and the control module 130 which controls the operation of the apparatus main body. The broadcast receiving apparatus 100 has an input-side selector module 114 and an output-side selector module 120. A BS/CS/terrestrial digital tuner module 112 and a BS/terrestrial analog tuner module 113 are connected to the input-side selector module 114. A LAN or a communication module 111 having a mail function is connected to the data bus.

The broadcast receiving apparatus 100 also includes a buffer module 115 which temporarily stores a demodulated signal from the BS/CS/terrestrial digital tuner module 112, a demultiplexer module 117 which demultiplexes a stored packet as a demodulated signal into signals of different types, the MPEG decoder module 116 which executes MPEG decoding processing for video and audio packets supplied from the demultiplexer module 117 and outputs video and audio signals, and an OSD (On Screen Display) superimposition module 134 which generates a video signal to superimpose operation information or the like and superimposes it on a video signal. The broadcast receiving apparatus 100 also has an audio processing module 118 which, e.g., amplifies the audio signal from the MPEG decoder module 116, the video processing module 119 which receives the video signal from the MPEG decoder module 116 and executes desired video processing, the interpolation frame generation module 10 according to the above-described embodiment of the invention, the OSD superimposition module 134, the selector module 120 to select the output destinations of the audio signal and video signal, a speaker module 121 which outputs audio corresponding to the audio signal from the audio processing module 118, a display module 122 which is connected to the selector module 120 and displays, on a liquid crystal display screen or the like, an image corresponding to the supplied video signal, and an interface module 123 which communicates with an external device.

The broadcast receiving apparatus 100 also includes a storage module 135 which records video information and the like from the BS/CS/terrestrial digital tuner module 112 and the BS/terrestrial analog tuner module 113, as needed, and an electronic program information processing module 136 which acquires electronic program information from a broadcast signal and displays it on the screen. These modules are connected to the control module 130 via the data bus. The broadcast receiving apparatus 100 also has an operation module 132 which is connected to the control module 130 via the data bus and receives a user operation or an operation of a remote controller R, and a display module 133 which displays an operation signal. The remote controller R enables almost the same operation as the operation module 132 provided on the main body of the broadcast receiving apparatus 100 and can do various kinds of settings such as a tuner operation.

In the broadcast receiving apparatus 100 having the above-described arrangement, a broadcast signal is input from a receiving antenna to the BS/CS/terrestrial digital tuner module 112, and a channel is selected. The demultiplexer module 117 demultiplexes the demodulated signal in a packet format for the selected channel into packets of different types. Audio and video packets are decoded by the MPEG decoder module 116 so that audio and video signals are supplied to the audio processing module 118 and the video processing module 119, respectively.

In the video processing module 119, for example, an IP conversion module 141 executes image processing of the received video signal by, e.g., converting the interlaced signal into a progressive signal. Additionally, the interpolation frame generation module 10 can supplies, to the selector module 120, a video signal which is interpolated to allow smooth moving image playback based on reliable motion vector detection.

The selector module 120 supplies the video signal to, e.g., the display module 122 in accordance with a control signal from the control module 130 so that the display module 122 displays an image corresponding to the video signal. In addition, the speaker module 121 outputs audio corresponding to the audio signal from the audio processing module 118.

Various kinds of operation information and subtitle information generated by the OSD superimposition module 134 are superimposed on the video signal corresponding to the broadcast signal. An image corresponding to the video signal is displayed on the display module 122 via the video processing module 119.

As described above, in the broadcast receiving apparatus 100, for example, it is possible to display a moving image with a smooth motion without any failure based on reliable motion vector detection by the interpolation frame generation module 10.

The various modules of the systems described herein can be implemented as software applications, hardware and/or software modules, or components on one or more computers, such as servers. While various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An interpolation frame generation apparatus for generating an interpolation frame image to be inserted between continuous frame images, comprising:
a block specific detector configured to execute block matching processing in one of blocks included in the continuous frame images and determine a block specific motion vector;
a pixel specific detector configured to, for each pixel of a block of interest of the blocks, define, as a candidate vector, a motion vector most frequently applied among pixel specific motion vectors already determined in a block adjacent to the block of interest and execute matching processing between the candidate vector and each pixel of the block of interest, thereby detecting a pixel specific motion vector; and
a generator configured to generate an interpolation frame image based on the block specific motion vector and the pixel specific motion vector.

2. The apparatus of claim 1, wherein the pixel specific detector handles, as the candidate vector, each of motion vectors detected by the block specific detector for adjacent blocks on upper, lower, left, and right sides of the block of interest and executes matching processing between the candidate vectors and each pixel of the block of interest, thereby detecting the pixel specific motion vector of the block of interest.

3. The apparatus of claim 1, wherein the pixel specific detector handles, as the candidate vector, a motion vector detected by the block specific detector for the block of interest and executes matching processing between the candidate vectors and each pixel of the block of interest, thereby detecting the pixel specific motion vector of the block of interest.

4. The apparatus of claim 1, wherein for each pixel of the block of interest of the blocks, the pixel specific detector defines, as the candidate vector, a motion vector most frequently applied among pixel specific motion vectors already determined in the block of interest in a frame image immediately preceding to the frame image and executes matching processing between the candidate vector and each pixel of the block of interest, thereby detecting the pixel specific motion vector.

5. The apparatus of claim 1, wherein for each pixel of the block of interest of the blocks, the pixel specific detector defines, as the candidate vector, a motion vector most frequently applied among pixel specific motion vectors already determined in the block of interest in an nth (n is an integer) frame image preceding to the frame image and executes matching processing between the candidate vector and each pixel of the block of interest, thereby detecting the pixel specific motion vector.

6. The apparatus of claim 1, wherein after the block specific detector determines motion vectors of all of the blocks included in the frame image, the pixel specific detector detects the pixel specific motion vector in each of the blocks by referring to the motion vectors of all of the blocks.

7. The apparatus of claim 1, wherein the pixel specific detector detects motion vectors of all pixels of one block, determines a most frequently applied vector of the block, and stores the most frequently applied vector.

8. The apparatus of claim 1, wherein the pixel specific detector sequentially performs pixel specific motion vector detection processing of the block of interest of the blocks in one of a vertical direction and a horizontal direction in the frame image.

9. An interpolation frame generation method of generating an interpolation frame image to be inserted between continuous frame images, comprising:
executing block matching processing in one of blocks included in the continuous frame images and determining a block specific motion vector;
defining, as a candidate vector for each pixel of a block of interest of the blocks, a motion vector most frequently applied among pixel specific motion vectors already determined in a block adjacent to the block of interest;
executing matching processing between the candidate vector and each pixel of the block of interest, thereby detecting a pixel specific motion vector; and
generating an interpolation frame image based on the block specific motion vector and the pixel specific motion vector.

10. A broadcast receiving apparatus comprising:
a tuner configured to receive a broadcast signal and output a video signal;
a block specific detector configured to execute block matching processing in one of blocks included in continuous frame images contained in the video signal from the tuner and determine a block specific motion vector;
a pixel specific detector configured to, for each pixel of a block of interest of the blocks, define, as a candidate vector, a motion vector most frequently applied among pixel specific motion vectors already determined in a block adjacent to the block of interest and execute matching processing between the candidate vector and each pixel of the block of interest, thereby detecting a pixel specific motion vector;
a generator configured to generate an interpolation frame image based on the block specific motion vector and the pixel specific motion vector and interpolate the video signal from the tuner; and
a display configured to display, on a screen, an image based on the video signal interpolated by the generator.
